(19) United States
(12) Patent Application Publication
(10) Pub. No.: US 2016/0126827 A1
(43) Pub. Date: May 5, 2016

(54) SUB-MODULE, PROTECTION UNIT, CONVERTER, AND CONTROL METHOD THEREOF

(71) Applicants: NR ELECTRIC CO., LTD., Nanjing (CN); NR ENGINEERING CO., LTD., Nanjing (CN)

(72) Inventors: Yunlong DONG, Nanjing (CN); Dongming CAO, Nanjing (CN); Jie TIAN, Nanjing (CN); Haiying LI, Nanjing (CN); Nannan WANG, Nanjing (CN)

(73) Assignees: NR ENGINEERING CO., LTD., Nanjing (CN); NR ELECTRIC CO., LTD., Nanjing (CN)

(21) Appl. No.: 14/891,363

(22) PCT Filed: May 5, 2014
(86) PCT No.: PCT/CN2014/076781

§ 371 Date: Nov. 16, 2015

(30) Foreign Application Priority Data
May 15, 2013 (CN) 201310179826.4
Dec. 26, 2013 (CN) PCT/CN2013/090486

(51) Int. Cl. H02M 1/32

(52) U.S. Cl. CPC H02M 1/32

(57) ABSTRACT

Disclosed are a submodule structure formed of an energy storage element, a first turn-off device, a second turn-off device, a third turn-off device, a freewheeling diode, a series resistor, and diodes respectively in antiparallel connection with the turn-off devices, and a converter completely or partially formed of the submodules. Also disclosed are a relevant protection unit and a control method for the converter. The converter can be locked when a direct current (DC) fault occurs to prevent an alternating current (AC) system from injecting a fault current into a DC network, so that a transient fault of the DC network can be removed without tripping an AC line switch, thereby rapidly restarting the system. A charging resistor is comprised in the submodule so that a charging resistor disposed at an AC side of the converter can be reduced and even may not be disposed.

### BACKGROUND OF THE INVENTION

1. Field of the Invention

The present invention relates to the field of power and electronics, and in particular, to a submodule, a protection unit, and a voltage source in multilevel convertor and a control method thereof.

2. Description of Related Art

A modularized multilevel converter is a new converter applicable to high voltage applications and attracting much attention in recent years. In the modularized multilevel converter, submodules are cascaded, where the state of each submodule is separately controlled to enable an alternating voltage outputted by the converter to approach a sine wave, thereby reducing a harmonic content in the output voltage. The modularized multilevel converter solves the series average-voltage problem existing in a two-level voltage source converter and has wide application prospects.

In the “distributed energy stores and converter circuit” of Marquardt Rainer, a modularized multilevel converter (MMC) was first mentioned (patent application publication No.: DE10103031A), where a submodule of the converter is formed of a half-bridge and a capacitor connected in parallel and two levels, a capacitor voltage and a 0 voltage, can be generated through control at an output port of the submodule. In 2010, the Trans Bay project, a flexible direct current (DC) transmission project first adopting this topological structure all over the world and undertaken by the Siemens corporation was successfully put into operation, which proves the feasibility of engineering applications of the topological structure of this converter.

On the basis of the topological structure of the modularized multilevel converter. the ABB corporation has modified the structure and proposed a cascade two-level modularized multilevel topological structure (patent application publication No.: US20100328977A1), where this converter differs from the foregoing modularized multilevel converter that connection of the submodules is reversed.

The disadvantages of the two modularized multilevel converters are that, when a fault occurs in a DC network, an alternating current (AC) network can provide a fault current to a fault point through a diode of the submodule, resulting in over-currents at AC and DC sides and at a converter valve, so the DC fault must be removed by tripping an line switch. When a transient fault occurs in the DC network, AC line switches need to be tripped for all of the foregoing two modularized multilevel converters connected to the DC network, so that it takes a long time to restore electricity transmission.

### SUMMARY OF THE INVENTION

### Technical Problem

The objectives of the present invention are to provide a submodule, where a converter can be locked when a DC fault occurs to prevent an AC system from injecting a fault current into a DC network, so that a transient fault of the DC network can be removed without tripping an AC line switch, thereby rapidly restarting the system. In addition, further provided are a protection unit, a converter corresponding to the submodule, and a control method.

### Technical Solution

In order to achieve the above objectives, the present invention adopts the following technical solutions:

### Advantageous Effect

Through the above technical solutions, the beneficial effects of the present invention are as follows:

(1) when a fault occurs in a DC network, the converter is locked to prevent an AC network from injecting a fault current into a fault point;

(2) when a transient fault occurs at a DC side, the fault is removed without tripping an AC line switch; and

(3) no DC breaker is required for a two-terminal or multi-terminal DC system formed of the converter provided by the present invention.

### BRIEF DESCRIPTION OF THE DRAWINGS

FIG. 1 is a topological structure diagram of an embodiment of a submodule of the present invention.

FIG. 2 is a topological structure diagram of an embodiment of a submodule of the present invention.

FIG. 3 is a topological structure diagram of an embodiment of a submodule of the present invention.

FIG. 4 is a topological structure diagram of an embodiment of a submodule of the present invention.

FIG. 5 is a topological structure diagram of a converter completely formed of submodules provided by the present invention.

FIG. 6 is two topological structure diagrams of an additional submodule in the present invention.

FIG. 7 is a topological structure diagram of a converter partially formed of submodules provided by the present invention.

FIG. 8 is a schematic diagram of an embodiment of a control method for the converter of the present invention.

FIG. 9 is a schematic diagram of an embodiment of a control method for the converter of the present invention.

FIG. 10 is four topological structure diagrams of a protection unit for a submodule in the present invention.

FIG. 11 is a schematic diagram of a connection manner of a protection unit for a submodule in the present invention and the submodule.

### DETAILED DESCRIPTION OF THE INVENTION

The technical solutions of the present invention are described in detail below in combination with accompanying drawings and specific embodiments.

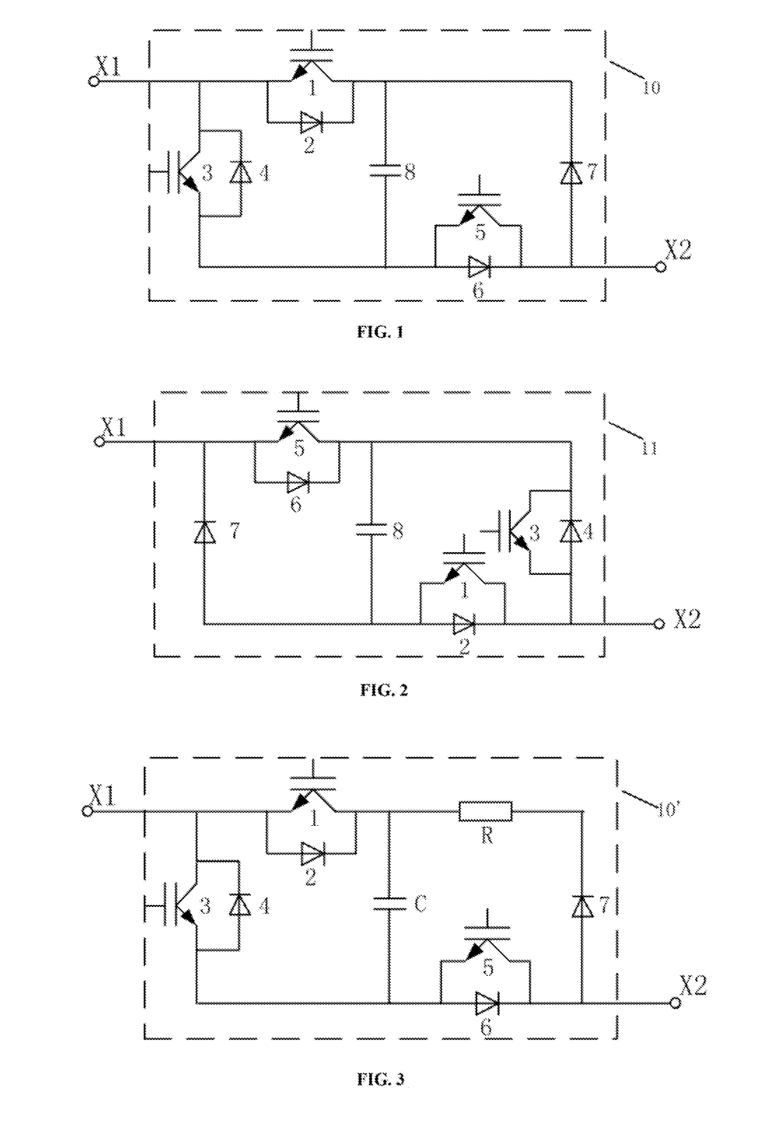

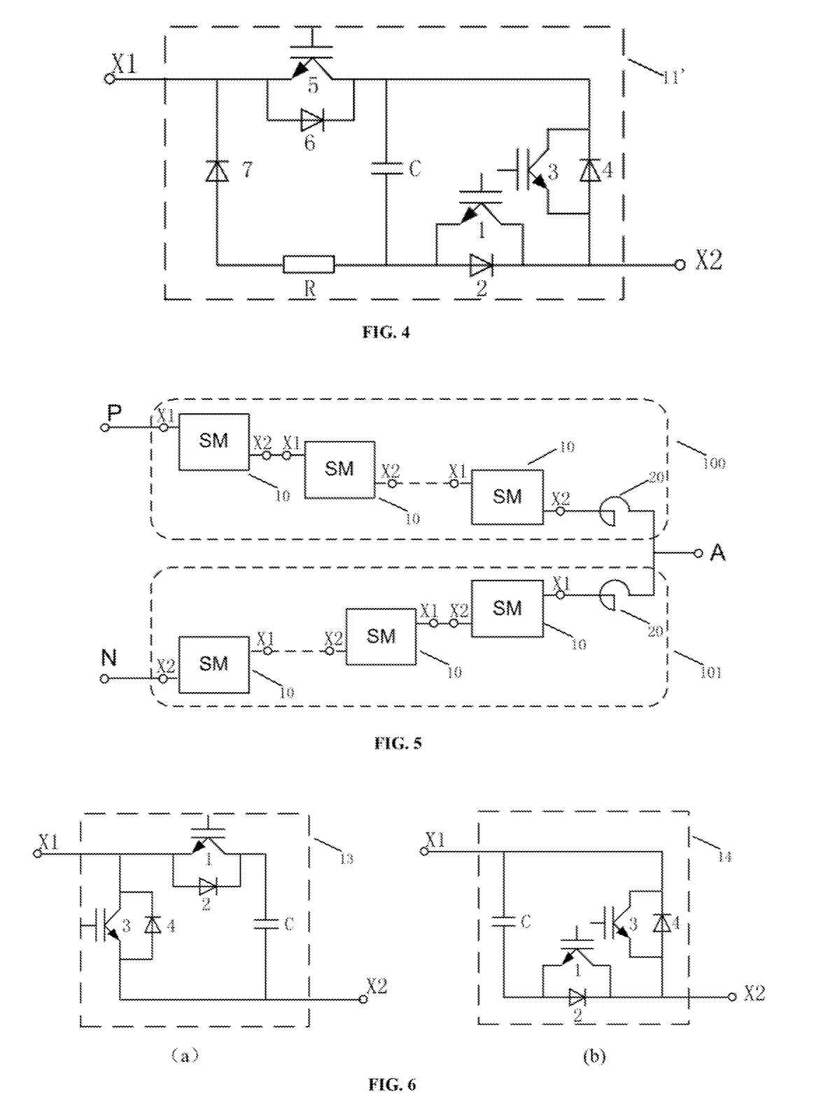

FIG. 1 to FIG. 4 are topological structure diagrams of preferred embodiments of a submodule provided by the present invention. FIG. 1 and FIG. 2 show a situation where no resistor is contained in the freewheeling diode branch. FIG. 3 and FIG. 4 show a situation where a resistor is contained in the freewheeling diode branch.

As shown in FIG. 1 and FIG. 2, the submodule comprises turn-off devices 1, 3, 5 in antiparallel connection with diodes and an energy storage element 8, where the turn-off device 1 is in antiparallel connection with the diode 2, the turn-off device 3 is in antiparallel connection with the diode 4, and the turn-off device 5 is in antiparallel connection with the diode 6. Each of the turn-off devices 1, 3, 5 may be a single controlled switch device (for example, a fully controlled device such as an IGBT, an IGCT, a MOSFET or a GTO, where in the embodiments provided herein, the IGBT is taken as an example) and may also be of a structure formed of at least two controlled switch devices connected in series.

FIG. 1 shows a submodule 10. An emitter of the turn-off device 1 is connected to a collector of the turn-off device 3, with the connection point being used as a terminal X1 of the submodule 10. A collector of the turn-off device 1 is connected to an emitter of the turn-off device 3 through the energy storage element 8. The collector of the turn-off device 1 is also connected to a cathode of a diode 7. An anode of the diode 7 is connected to a collector of the turn-off device 5, with the connection point being used as a terminal X2 of the submodule 10. An emitter of the turn-off device 5 is connected to the emitter of the turn-off device 3.

FIG. 2 shows a submodule 11. An emitter of a turn-off device 5 is connected to a cathode of a diode 7, with the connection point being used as a terminal X1 of the submodule 11. A collector of the turn-off device 5 is connected to an anode of the diode 7 through the energy storage element 8. The collector of the turn-off device 5 is also connected to a collector of the turn-off device 3. An emitter of the turn-off device 3 is connected to a collector of the turn-off device 1, with the connection point being used as a terminal X2 of the submodule 11. An emitter of the turn-off device 1 is connected to the anode of the diode 7.

As shown in FIG. 3 and FIG. 4, the submodule comprises turn-off devices 1, 3, 5 in antiparallel connection with diodes and an energy storage element C, where the turn-off device 1 is in antiparallel connection with the diode 2, the turn-off device 3 is in antiparallel connection with the diode 4, and the turn-off device 5 is in antiparallel connection with the diode 6. Each of the turn-off devices 1, 3, 5 may be a single controlled switch device (for example, a fully controlled device such as an IGBT, an IGCT, a MOSFET or a GTO, where in the embodiments provided herein, the IGBT is taken as an example) and may also be of a structure formed of at least two controlled switch devices connected in series.

FIG. 3 shows a submodule 10′. A collector of the turn-off device 1 is connected to an emitter of the turn-off device 3, with the connection point being used as a terminal X1 of the submodule 10′. An emitter of the turn-off device 1 is connected to a collector of the turn-off device 3 through the energy storage element C. The collector of the turn-off device 1 is also connected to a series resistor R and the other end of the series resistor is connected to a cathode of a diode 7. An anode of the diode 7 is connected to a collector of the turn-off device 5, with the connection point being used as a terminal X2 of the submodule 10. The collector of the turn-off device 5 is connected to the collector of the turn-off device 3. Locations of the series resistor R and the diode 7 can be exchanged as long as it can be ensured that the anode of the diode 7 is connected to the terminal X2 directly or through the series resistor R.

FIG. 4 shows a submodule 11′, which is obtained by changing the topological structure of the submodule shown in FIG. 3 in the following manner: locations of the terminal X1 and the terminal X2 in are exchanged, locations of the collector and the emitter of each turn-off device are exchanged, and locations of the anode and the cathode of each diode are exchanged. The collector of the turn-off device 5 is connected to the cathode of the diode 7, with the connection point being used as a terminal X1 of the submodule 11. The emitter of the turn-off device 5 is connected to one end of the series resistor R through the energy storage element C and the other end of the series resistor R is connected to the anode of the diode 7. The collector of the turn-off device 5 is also connected to the collector of the turn-off device 3. The emitter of the turn-off device 3 is connected to the collector of the turn-off device 1, with the connection point being used as a terminal X2 of the submodule 11. The collector of the turn-off device 1 is connected to the one end of the series resistor R. Locations of the series resistor R and the diode 7 can be exchanged as long as it can be ensured that the cathode of the diode 7 is connected to the terminal X1 directly or through the series resistor R.

It should be noted that, only equivalent elements for the turn-off devices, the resistor, and the freewheeling diode are described in the embodiments of the present invention. That is to say, the turn-off devices, the resistor, and the freewheeling diode can each be formed by cascading multiple elements. For example, an equivalent resistor may be formed of multiple resistors connected in series or in parallel, an equivalent freewheeling diode ma be formed of multiple freewheeling diodes connected in series or in parallel, and so on.

It should be noted that, in the embodiments described in FIG. 3 and FIG. 4, the series resistor is an equivalent representation, that is, the locations and the number of resistors and freewheeling diodes are not limited and the resistors and the freewheeling diodes can be arranged alternately.

FIG. 5 shows a preferred embodiment of a converter of the present invention. Each submodule in the converter is one provided by the present invention. The converter comprises at least one phase unit. The specific number of phase units can be determined according to the number of AC terminals of an AC system. Each of the phase units comprises an upper bridge arm 100 and a lower bridge arm 101. Each of the upper bridge arm and the lower bridge arm comprises at least two submodules 10 and at least one reactor 20 connected to each other in series. The number of submodules and reactors comprised in the upper bridge arm may be the same as or different from the number of submodules and reactors comprised in the lower bridge arm. Each submodule 10 has two terminals X1 and X2. All of the submodules 10 in the same bridge arm (the upper bridge arm or the lower bridge arm) are connected in the same direction and connection directions of the submodules in the upper bridge arm and the lower bridge arm are opposite to each other, as shown in FIG. 3. One end of the upper bridge arm 100 is used as a first DC terminal P of the phase unit to be connected to a DC network. One end of the lower bridge arm 101 is used as a second DC terminal N of the phase unit to be connected to the DC network. The other ends of the upper bridge arm 100 and the lower bridge arm 101 are jointly used as an AC terminal A of the phase unit to be connected to an AC network. It should be noted that, for the upper bridge arm 100 or the lower bridge arm 101, a series location of the submodules 10 and the reactors 20 is not limited and because one reactor can be formed of multiple reactors connected in series, the number of reactors is not limited as long as a total reactance value in a certain bridge arm meets a requirement corresponding to the bridge arm.

It should be noted that, the submodule 10 in FIG. 3 may also be replaced with any one of the four submodules provided above.

FIG. 6 is two topological structure diagrams of an additional submodule in the present invention. The cost of the converter can be reduced by replacing the submodules in the converter shown in FIG. 5 with the additional submodule. The additional submodule comprises turn-off devices 1, 3 in antiparallel connection with diodes and an energy storage element C, where the turn-off device 1 is in antiparallel connection with the diode 2 and the turn-off device 3 is in antiparallel connection with the diode 4. Each of the turn-off devices 1, 3 may be a single controlled switch device (for example, a fully controlled device such as an IGBT, an IGCT, a MOSFET or a GTO, where in the embodiments provided herein, the IGBT is taken as an example) and may also be of a structure formed of at least two controlled switch devices connected in series. FIG. 6(a) shows a submodule 12. A collector of the turn-off device 1 is connected to an emitter of the turn-off device 3, with the connection point being used as a terminal X1 of the submodule 12. An emitter of the turn-off device 1 is connected to a collector of the turn-off device 3 through the energy storage element C. The collector of the turn-off device 3 is used as a terminal X2 of the submodule 12. FIG. 6(b) shows a submodule 13. A collector of the turn-off device 3 is connected to an emitter of the turn-off device 1, with the connection point being used as a terminal X2 of the submodule 13. An emitter of the turn-off device 1 is connected to a collector of the turn-off device 3 through the energy storage element C. The collector of the turn-off device 3 is used as a terminal X1 of the submodule 12.

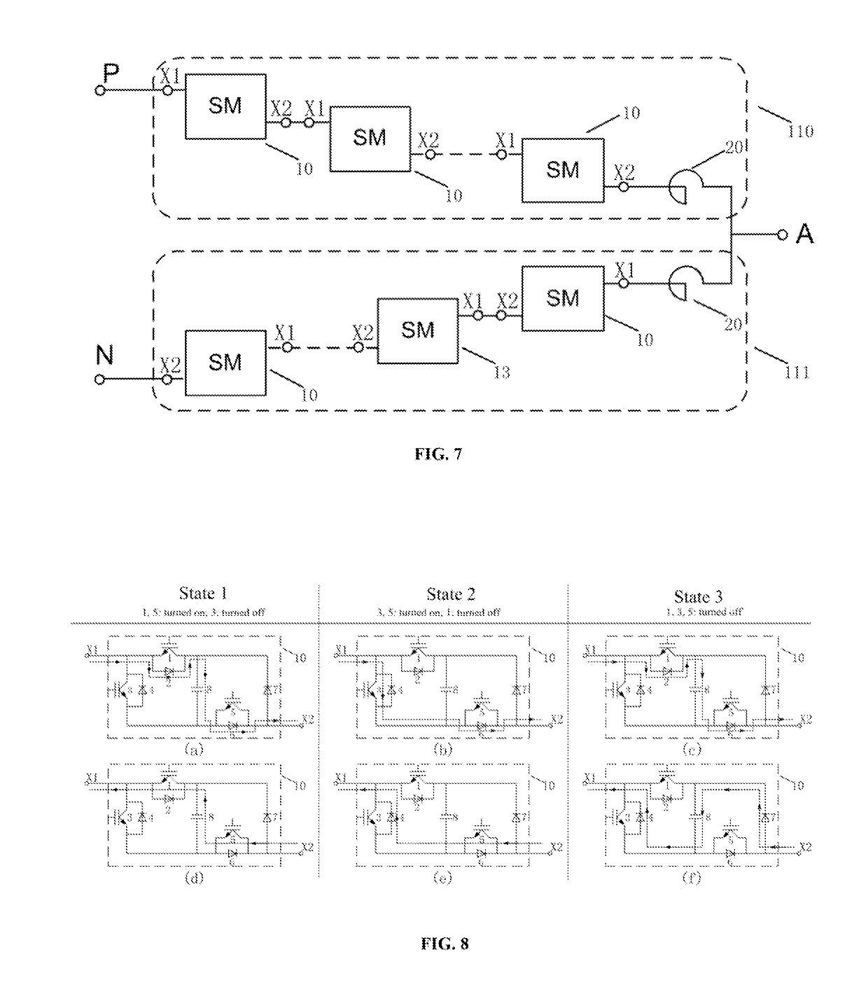

FIG. 7 shows a preferred embodiment of a converter of the present invention, where one of the submodules in the lower bridge arm of the converter shown in FIG. 5 is replaced with the submodule 13. The number of turn-off devices is reduced, thereby saving the cost of the converter. It should be noted that, the converter obtained after replacement should comprise at least one submodule provided by the present invention, and then any number of submodules of the present invention at any location in the converter shown in FIG. 5 can be replaced with the additional submodule.

The present invention further provides a control method for the converter as described above, where the converter is controlled by controlling an operation state of each submodule in the converter. The control content of the control method is described below by taking the submodules 10, 11 provided in FIG. 1 and FIG. 2 of the present invention as examples. The control methods for the converters formed by the submodules 10′, 11′ in FIG. 3 and FIG. 4 are similar and are not described again.

FIG. 8(a) and FIG. 8(d) are schematic diagrams of two current directions in a state 1 respectively, FIG. 8(b) and FIG. 8(e) are schematic diagrams of two current directions in a state 2 respectively, and FIG. 8(c) and FIG. 8(f) are schematic diagrams of two current directions in a state 3 respectively.

The submodule 10 is controlled to operate in the three operation states. In the state 1, the turn-off devices 1, 5 are turned on, the turn-off device 3 is turned off, and the energy storage element C is connected to the bridge arm through the diode 2 and the diode 6 (see FIG. 8(a)) or the energy storage element C is connected to the bridge arm through the turn-off devices 5, 1 (see FIG. 8(d)), so that an output voltage (that is, a voltage of the terminal X1 relative to terminal X2) of the submodule 10 is a voltage across the energy storage element C. In the state 2, the turn-off devices 3, 5 are turned on and the turn-off device 1 is turned off, so that a current can flow through the turn-off device 3 and the diode 6 (see FIG. 8(b)) or the turn-off device 5 and the diode 4 (see FIG. 8(e)), the energy storage element C is bypassed, and an output voltage of the submodule 10 is 0. In the state 3, the turn-off devices 1, 3, 5 are all turned off, so that when a current flows from the terminal X1 to the terminal X2, the diode 2 and the diode 6 are turned on, the energy storage element C is connected to the bridge arm through the terminal X1 and the terminal X2, and an output voltage of the submodule 10 is a voltage across the energy storage element C (see FIG. 8(c)); and when a current flows from the terminal X2 to the terminal X1, the diode 7 and the diode 4 are turned on, the energy storage element C is reversely connected to the bridge arm through the terminal X1 and the terminal X2 (see FIG. 8(f)), and an output voltage of the submodule 10 is a negative number of a voltage across the energy storage element C plus a voltage across the resistor. When the submodule operates in the state 3, the output voltage of the submodule 10 and the current flowing in the submodule 10 are in the opposite directions, so a fault current can be restrained and is eventually 0. The addition of the series resistor R accelerates the attenuation of the fault current.

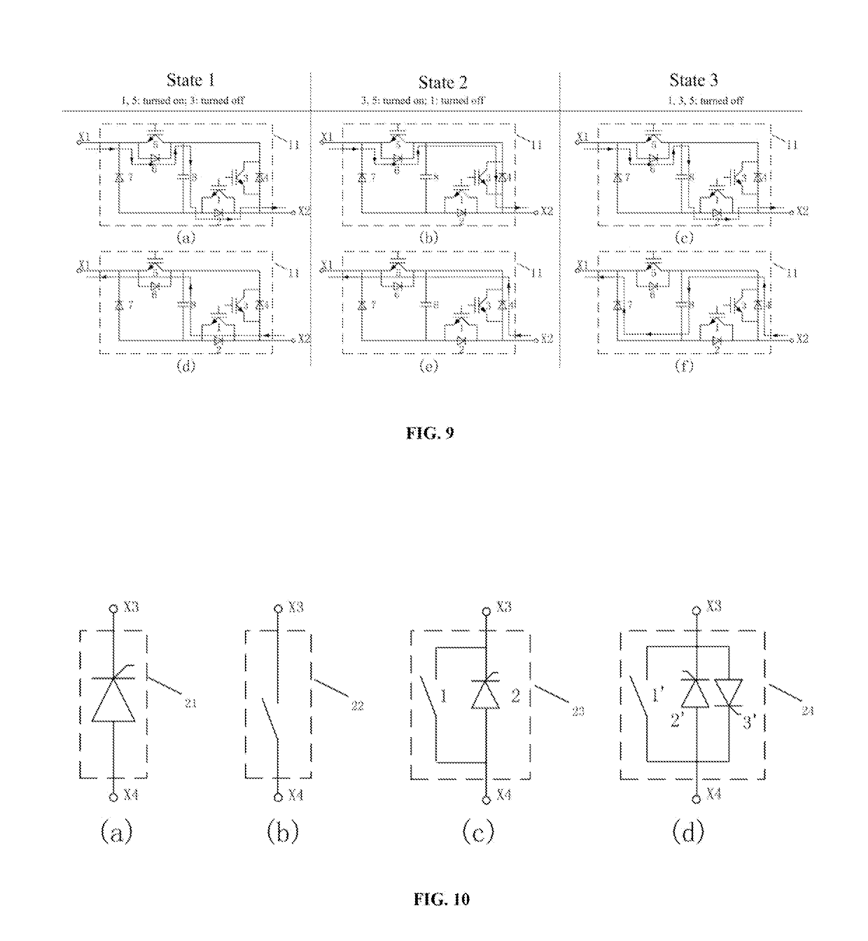

FIG. 9(a) and FIG. 9(d) are schematic diagrams of two current directions in a state 1 respectively, FIG. 9(b) and FIG. 9(e) are schematic diagrams of two current directions in a state 2 respectively, and FIG. 9(c) and FIG. 9(f) are schematic diagrams of two current directions in a state 3 respectively.

The submodule 1 is controlled to operate in the three operation states. In the state 1, the turn-off devices 1, 5 are turned on, the turn-off device 3 is turned off, and the energy storage element C is connected to the bridge arm through the diode 6 and the diode 2 (see FIG. 9(a)) or the energy storage element C is connected to the bridge arm through the turn-off devices 1, 5 (see FIG. 9(d)), so that an output voltage (that is, a voltage of the terminal X1 relative to terminal X2) of the submodule 11 is a voltage across the energy storage element C. In the state 2, the turn-off devices 3, 5 are turned on and the turn-off device 1 is turned off, so that a current can flow through the diode 6 and the turn-off device 3 (see FIG. 9(b)) or the diode 4 and the turn-off device 5 (see FIG. 9(e)), the energy storage element C is bypassed, and an output voltage of the submodule 11 is 0. In the state 3, the turn-off devices 1, 3, 5 are all turned off, so that when a current flows from the terminal X1 to the terminal X2, the diode 6 and the diode 2 are turned on, the energy storage element C is connected to the bridge arm through the terminal X1 and the terminal X2, and an output voltage of the submodule 11 is a voltage across the energy storage element C (see FIG. 9(c)); and when a current flows from the terminal X2 to the terminal X1, the diode 4 and the diode 7 are turned on, the energy storage element C is reversely connected to the bridge arm through the terminal X1 and the terminal X2 (see FIG. 9(f)), and an output voltage of the submodule 11 is a negative number of a voltage across the energy storage element C plus a voltage across the resistor. When the submodule operates in the state 3, the output voltage of the submodule 11 and the current flowing in the submodule 11 are in the opposite directions, so a fault current can be restrained and is eventually 0. The addition of the series resistor R accelerates the attenuation of the fault current.

When a ground fault occurs in the DC network, the converter is locked so that the submodules 10 or 11 and possibly disposed additional submodule 12, 13 in the converter all operate in the state 3, thereby restraining the current of a bridge arm on the failure and eventually reducing it to 0. As a result, the AC network cannot provide a fault current to a fault point. When a transient fault occurs at the DC side, the fault can be removed without tripping an AC line switch, and a two-terminal or multi-terminal DC system formed of the converter provided by the present invention can have good ability of removing the fault at the DC side without a DC breaker.

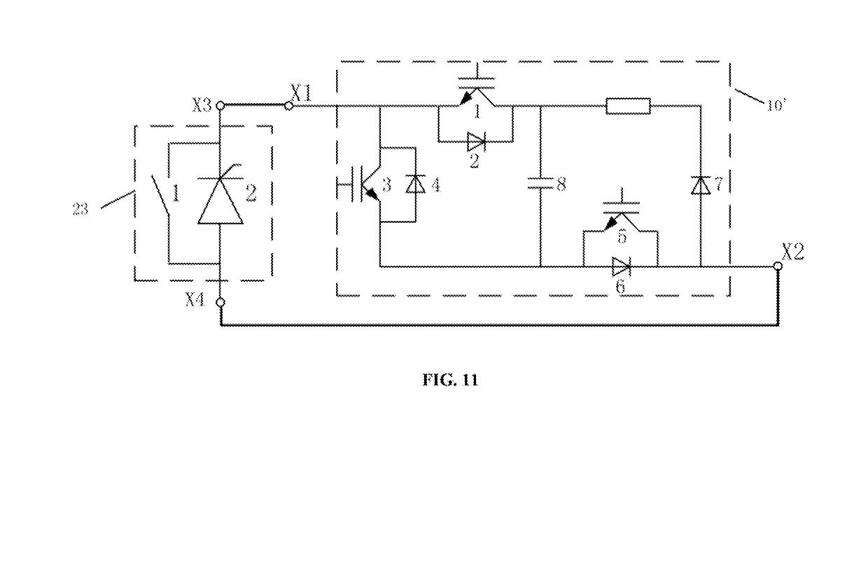

In addition, the present invention further provides a protection unit. The protection unit may be used in the submodule provided by the present invention and may also be used for protecting other types of full-bridge or half-bridge submodules. The protection unit may be of four structures. FIG. 10(a) shows a protection unit formed of a single thyristor. FIG. 10(b) shows a protection unit formed of a single high-speed switch. FIG. 10(c) shows a protection unit formed of a thyristor and a high-speed switch connected to each other in parallel. FIG. 10(d) shows a protection unit formed of antiparallel thyristors and a high-speed switch connected to each other in parallel.

FIG. 10(a) shows a protection unit 21 formed of a single thyristor, where a cathode of the thyristor is used as a terminal X3 of the protection unit 21 and an anode of the thyristor is used as a terminal X4 of the protection unit 21, so that when an overcurrent occurs in a submodule, the protection unit 21 can be quickly turned on for shunting, thereby protecting the submodule. FIG. 10(b) shows a protection unit 22 formed of a single high-speed switch, where one end of the high-speed switch is used as a terminal X3 of the protection unit and the other end of the high-speed switch is used as a terminal X4 of the protection unit, so that when a fault occurs in a submodule, the faulty submodule can be bypassed and if the bridge arm where the faulty submodule is located has a redundant submodule, the converter can continue to operate. FIG. 10(c) shows a protection unit 23 formed of as thyristor and a high-speed switch connected to each other in parallel, where a cathode of the thyristor is used as a terminal X3 of the protection unit, an anode of the thyristor is used as a terminal X4 of the protection unit, one end of the high-speed switch is connected to the cathode of the thyristor, and the other end of the high-speed switch is connected to the anode of the thyristor, thereby achieving overcurrent protection and active bypassing for a submodule. FIG. 10(d) shows a protection unit 24 formed of antiparallel thyristors and a high-speed switch connected to each other in parallel, where one end of the antiparallel thyristors 2′ and 3′ is used as a terminal X3 of the protection unit, the other end of the antiparallel thyristors 2′ and 3′ is used as a terminal X4 of the protection unit, one end of the high-speed switch 1′ is connected to the terminal X3, and the other end of the high-speed switch 1′ is connected to the terminal X4.

FIG. 11 is a schematic diagram of a connection manner of the protection unit 23 and the submodule 10. The terminal X3 of the protection unit 23 is connected to the terminal X1 of the submodule 10 and the terminal X4 of the protection unit 23 is connected to the terminal X2 of the submodule 10. It should be noted that, the protection unit 23 in FIG. 9 can be replaced with the protection unit 21, the protection unit 22, or the protection unit 24 and the submodule 10 may be replaced with the submodule 11.

When a ground fault occurs in the DC network, the converter is locked so that the submodules 10 or 11 in the converter all operate in the state 3, thereby restraining the current of the bridge arm on the fault and eventually reducing it to 0. As a result, the AC network cannot provide a fault current to a fault point. When a transient fault occurs at the DC side, the fault can be removed without tripping an AC line switch, and a two-terminal or multi-terminal DC system formed of the converter provided by the present invention can have good ability of removing the fault at the DC side without a DC breaker.

The above embodiments are only intended to describe technical ideas of the present invention and are not intended to limit the scope of the present invention. All changes made according to the technical ideas of the present invention on the basis of the technical solutions fall within the scope of the present invention.

What is claimed is:

1. A submodule, comprising an energy storage element, a first turn-off device, a second turn-off device, a third turn-off device, a freewheeling diode, and diodes respectively in antiparallel connection with the turn-off devices, characterized in that, either of the following two types of topology is adopted:
i) a negative electrode of the first turn-off device is connected to a positive electrode of the second turn-off device, with the connection point being used as a first terminal of the submodule, a positive electrode of the first turn-off device is connected to a negative electrode of the second turn-off device through the energy storage element, and a negative electrode of the third turn-off device is connected to the negative electrode of the second turn-off device; one end of the freewheeling diode branch is connected to the positive electrode of the first turn-off device; the other end of the freewheeling diode branch is connected to a positive electrode of the third turn-off device, with the connection point being used as a second terminal of the submodule; and
ii) a negative electrode of the third turn-off device is connected to a cathode of the diode, with the connection point being used as a first terminal of the submodule; a positive electrode of the third turn-off device is connected to a positive electrode of the second turn-off device, a negative electrode of the second turn-off device is connected to a positive electrode of the first turn-off device, with the connection point being used as a second terminal of the submodule, and the positive electrode of the third turn-off device is connected to a negative electrode of the first turn-off device through the energy storage element; as a series branch, the freewheeling diode has one end connected to the negative electrode of the first turn-off device and the other end connected to the negative electrode of the third turn-off device.

2. The submodule according to claim 1, characterized in that, the turn-off devices each are a single controlled switch device or is formed of at least two controlled switch devices connected in series.

3. The submodule according to claim 1, characterized in that, the energy storage element is a capacitor.

4. The submodule according to claim 2, characterized in that, the controlled switch device is an IGBT, an IEGT, an IGCT, a MOSFET or a GTO.

5. The submodule according, to claim 1, characterized in that, when the turn-off devices are an IGBT or an IEGT, the positive electrode is a collector and the negative electrode is an emitter; when the turn-off devices are an IGCT or a GTO, the positive electrode is an anode and the negative electrode is a cathode; when the turn-off devices are a MOSFET, the positive electrode is an emitter and the negative electrode is a collector.

6. The submodule according to claim 1, characterized in that, a resistor is connected to the freewheeling diode branch in series.

7. The submodule according to claim 1, characterized by further comprising a protection unit, wherein a first terminal of the protection unit is connected to the first terminal of the submodule and a second terminal of the protection unit is connected to the second terminal of the submodule; the protection unit has any one or more of the following four topological structures:
i) the protection unit is formed of a thyristor, wherein a cathode of the thyristor is the first terminal of the protection unit and an anode of the thyristor is the second terminal of the protection unit;
ii) the protection unit, is formed of a high-speed switch, wherein one end of the high-speed switch is the first terminal of the protection unit and the other end of the high-speed switch is the second terminal of the protection unit;
iii) the protection unit is formed of a thyristor and a high-speed switch connected to each other in parallel, wherein a cathode of the thyristor is the first terminal of the protection unit, an anode of the thyristor is the second terminal of the protection unit, one end of the high-speed switch is connected to the cathode of the thyristor, and the other end of the high-speed switch is connected to the anode of the thyristor; and
iv) the protection unit is formed of at least two antiparallel thyristors and a high-speed switch connected to each other in parallel, wherein one end of the antiparallel thyristors is the first terminal of the protection unit, the other end of the antiparallel thyristors is the second terminal of the protection unit, one end of the high-speed switch is connected to the first terminal of the protection unit, and the other end of the high-speed switch is connected to the second terminal of the protection unit.

8. The submodule according to claim 7, characterized in that, when a fault occurs in the submodule, if the parallel protection unit is of the topological structure i) or ii), the thyristor is triggered or the high-speed switch is closed to protect the submodule; if the parallel protection unit is of the topological structure iii) or iv), the thyristor is triggered and the high-speed switch is closed to protect the submodule.

9. A protection unit, used for a submodule of a voltage source multi-level converter and comprising a first terminal and a second terminal, characterized in that, the first terminal of the protection unit is connected to a first terminal of the submodule and the second terminal of the protection unit is connected to a second terminal of the submodule; the protection unit has any one or more of the following four topological structures:
i) the protection unit is formed of a thyristor, wherein a cathode of the thyristor is the first terminal of the protection unit and an anode of the thyristor is the second terminal of the protection unit;
ii) the protection unit is formed of a high-speed switch, wherein one end of the high-speed switch is the first terminal of the protection unit and the other end of the high-speed switch is the second terminal of the protection unit;
iii) the protection unit is formed of a thyristor and a high-speed switch connected to each other in parallel, wherein a cathode of the thyristor is the first terminal of the protection unit, an anode of the thyristor is the second terminal of the protection unit, one end of the high-speed switch is connected to the cathode of the thyristor, and the other end of the high-speed switch is connected to the anode of the thyristor; and
iv) the protection unit is formed of at least two antiparallel thyristors and a high-speed switch connected to each other in parallel, wherein one end of the antiparallel thyristors is the first terminal of the protection unit, the other end of the antiparallel thyristors is the second terminal of the protection unit, one end of the high-speed switch is connected to the first terminal of the protection unit, and the other end of the high-speed switch is connected to the second terminal of the protection unit.

10. The protection unit according to claim 9, characterized in that, when a fault occurs in the submodule, if the protection unit is of the topological structure i) or ii), the thyristor is triggered or the high-speed switch is closed to protect the submodule; if the protection unit is of the topological structure iii) or iv), the thyristor is triggered and the high-speed switch is closed to protect the submodule.

11. A converter, comprising at least one phase unit, wherein each phase unit comprises an upper bridge arm and a lower bridge arm, each of the upper bridge arm and the lower bridge arm comprises at least two submodules and at least one reactor connected to each other in series, all of the submodules in the same bridge arm are connected in the same direction, connection directions of the submodules in the upper bridge arm and the lower bridge arm are opposite to each other, one end of the upper bridge arm and one end of the lower bridge arm are used as to first direct current (DC) terminal and a second DC terminal of the phase unit respectively to be connected to a DC network, and the other end of the upper bridge arm and the other end of the lower bridge arm are shorted to each other as an alternating current (AC) terminal of the phase unit to be connected to an AC network; characterized in that, the submodule according to claim 1 is used in all or a part of the at least two submodules.

12. The converter according to claim 11, characterized in that, when the submodules are a part of all submodules in a certain bridge arm, an additional submodule is formed of a first turn-off device and a second turn-off device connected to each other in series, a diode in antiparallel connection with the first turn-off device, a diode in antiparallel connection with the second turn-off device, and an energy storage element, wherein the energy storage element is connected to a series branch of the first turn-off device and the second turn-off device in parallel.

13. The converter according to chum 12, characterized in that, in the additional submodule, a negative electrode of the first turn-off device is connected to a positive electrode of the second turn-off device, with the connection point being used as a first terminal, and a negative electrode of the second turn-off device is used as a second terminal.

14. The converter according to claim 12, characterized in that, in the additional submodule, a positive electrode of the second turn-off device is used as a first terminal, and a negative electrode of the second turn-off device is connected to a positive electrode of the first turn-off device, with the connection point being used as a second terminal.

15. The converter according to claim 12, characterized in that, in the additional submodule, the energy storage element is a capacitor.

16. The converter according to claim 12, characterized in that, in the additional submodule, the turn-off devices are an IGBT, an IEGT, an IGCT, a MOSTET or a GTO.

17. The converter according to claim 16, characterized in that, when the turn-off devices are an IGBT or an IEGT, the positive electrode is a collector and the negative electrode is an emitter; when the turn-off devices are an IGCT or a GTO, the positive electrode is an anode and the negative electrode is a cathode; when the turn-off devices are a MOSFET, the positive electrode is an emitter and the negative electrode is a collector.

18. A control method for the converter according to claim 11, wherein the convener is controlled by controlling an operation state of the submodules in the convener, characterized in that:
the control method for the submodule according to claim 1 is as follows: in a state 1, the first turn-off device and the third turn-off device are turned on and the second turn-off device is turned off, so that an output voltage of the submodule is a voltage across the energy storage element; in a state 2, the second turn-off device and the third turn-off device are turned on and the first turn-off device is turned off, so that an output voltage of the submodule is 0; in a state 3, the first turn-off device, the second turn-off device, and the third turn-off device are all turned off, an output voltage of the submodule is determined by a current direction; the output voltage of the submodule is a voltage of the first terminal of the submodule relative to the second terminal; and
the control method for the additional submodule is as follows: in a state 1, the first turn-off device is turned on and the second turn-off device is turned off, so that an output voltage of the submodule is a voltage across the energy storage element; in a state 2, the second turn-off device is turned on and the first turn-off device is turned off, so that an output voltage of the submodule is 0; in a state 3, the first turn-off device and the second turn-off device are both turned off, an output voltage of the submodule is determined by a current direction; the output voltage of the additional submodule is a voltage of the first terminal of the additional submodule relative to the second terminal.

19. The control method according to claim 18, wherein when it is detected that a fault occurs in a direct current (DC) system connected to the converter, all of the submodules are controlled to operate in the state 3 to lock the converter.
